(19) United States
(12) Patent Application Publication
(10) Pub. No.: US 2016/0161092 A1
(43) Pub. Date: Jun. 9, 2016

(54) SECURING MECHANISM FOR A LAMP BULB

(71) Applicant: POLYBRITE INTERNATIONAL, INC., Naperville, IL (US)

(72) Inventors: CARL SCIANNA, Des Plaines, IL (US); TED L. THOMPSON, West Lafyette, IL (US); JAMES A. SCHNEIDER, Shorewood, IL (US)

(21) Appl. No.: 14/960,239

(22) Filed: Dec. 4, 2015

Related U.S. Application Data
(60) Provisional application No. 62/087,447, filed on Dec. 4, 2014.

(51) Int. Cl. F21V 15/00

(52) U.S. Cl. CPC F21V 15/005

(57) ABSTRACT

Various apparatuses for locking a lamp bulb or luminaire, where a clamp assembly includes a first and second clamp portion having an arcuate shape and having plurality of cantilevers. The first and second portion may be configured to be joined along a circumference of a lamp or lamp base, wherein the clamp assembly is configured to lock the luminaire to a base via the first and second plurality of cantilevers. Locking rings with gears may also be used to restrict rotation of the lamp. A locking sleeve may also be used with a lock ring to secure a bulb via a fastener.

### RELATED APPLICATIONS

The present application claims priority to U.S. Provisional Patent Application No. 62/087,447 to Carl Scianna et al., titled “Securing Mechanism, for a Lamp Bulb,” filed Dec. 4, 2014, the entire contents of which is incorporated by reference in its entirety herein.

### TECHNICAL FIELD

The present disclosure relates to securing and/or locking lamp bulbs into a fixture or socket. More particularly, the present disclosure is directed to mechanisms for preventing unauthorized removal of luminaires and lamp bulbs after installation.

### BACKGROUND INFORMATION

Conventional incandescent and compact fluorescent bulbs have been traditionally inexpensive to manufacture and sell. Accordingly, they have been treated as “throw-away” items that did not require any form of security. Recently, with the advent of more advanced lighting technology, such as light emitting diode (LED) lamps, the cost of bulbs has increased significantly. Depending on the type of bulb used, the cost of a single bulb may be from $10 to over $80.

For individuals and businesses that utilize many bulbs that are accessible to the public (e.g., hotels, garages, etc.), the theft of bulbs has become an issue. Certain attempts have been made to prevent such theft by providing lockable enclosures over a light fixture (e.g., locked cage). However, such configurations are burdensome to install and maintain. What is needed is a mechanism and configuration that allows light bulbs to be secured in a manner that minimizes the opportunity for theft.

### BRIEF SUMMARY

In certain illustrative embodiments, an apparatus is disclosed for locking a luminaire, comprising a clamp assembly, wherein the clamp assembly includes a first clamp portion having an arcuate shape and comprising a first plurality of cantilevers, and a second clamp portion having an arcuate shape and comprising a second plurality of cantilevers. The first and second portion may be configured to be joined along a circumference of one of (i) a lamp or (ii) a lamp base, wherein the clamp assembly comprises openings configured to receive at least one fastener for securing the joined first and second portion, and wherein the clamp assembly is configured to lock the luminaire to a base via the first and second plurality of cantilevers.

In other illustrative embodiments, a locking mechanism is disclosed for a lamp bulb, comprising a locking ring comprising an upper portion and a lower portion, wherein the locking ring lower portion comprises generally cylindrical housing. The housing may comprise a plurality of hollowed portions for accommodating springs supporting a floating gear, wherein the locking ring upper portion comprises a generally circular housing comprising an upper gear, the locking ring upper portion being affixed to the lamp bulb and configured to receive the locking ring lower portion, and wherein the floating gear and upper gear comprise teeth that are configured to restrict rotation of the lamp in one direction when the teeth of the floating gear and lower gear are engaged during installation of the lamp bulb.

In further illustrative embodiment, a locking mechanism for a lamp bulb is disclosed, comprising a lock ring configured to be affixed to a base region of the lamp bulb, and a locking sleeve configured to be coupled to a lamp base, wherein the locking sleeve is configured to insertably receive the base region of the lamp bulb, wherein the locking sleeve comprises an extended enclosed opening configured to receive a fastener that passes into the extended enclosed opening to secure the lock ring to prevent removal of the lamp bulb from the lamp base.

### BRIEF DESCRIPTION OF THE DRAWINGS

The present invention is illustrated by way of example and not limitation in the figures of the accompanying drawings, in which like references indicate similar elements and in which:

FIG. 1 illustrates an exemplary embodiment of a locking clamp assembly with a clamp and security fastener coupled to a lamp bulb having an insulated lamp base;

FIGS. 2A-B illustrate exemplary embodiments of a clamp attachment with security fastener to a lamp bulb;

FIGS. 3A-B show exemplary embodiments illustrating a profile of a clamp's inside diameter matching profile of a lamp bulb providing self-alignment;

FIGS. 4A-B illustrate exemplary embodiments of an anchor secured to a ceramic lamp base;

FIGS. 5A-C shows exemplary embodiments illustrating cantilever spring heat exchangers utilized for a clamp;

FIGS. 6A-D illustrate exemplary embodiments of an installation of a secured lamp into a cover;

FIGS. 7A-F illustrate exemplary embodiments of engagement mechanisms for a clamp to a light bulb, including thread engagement and locking mechanism engagement;

FIGS. 8A-B illustrate exemplary embodiments of a light bulb engaging with a spring coupled lamp based comprising a floating gear;

FIGS. 9A-B illustrate exemplary embodiments of a spring coupled lamp based comprising a floating gear

FIGS. 10A-C illustrate exemplary embodiments of an upper gear welded onto a light bulb;

FIGS. 11A-B illustrate other embodiments of a spring coupled lamp based comprising a floating gear;

FIGS. 12A-C illustrate exemplary embodiments of a locking ring configured to be attached to a light bulb that is engaged by at least one fastener;

FIGS. 13A-B illustrate embodiments of bonding an anchor ring to a light bulb for the embodiments of FIGS. 12A-C; and

FIGS. 14A-B illustrate another exemplary embodiment of a locking ring configured to be attached to a light bulb that is engaged by at least one fastener; and

FIG. 15 illustrates an embodiment of a universal clamp and universal bonded clamp adapter for attachment to a light bulb.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

In the embodiments described below, various mechanisms are disclosed for securing a light bulb to a base portion of a luminaire (e.g., a complete electric light unit). While specific lamps and materials may be referenced herein, it should be understood by those skilled in the art that the features and characteristics described herein are equally applicable to other suitable lamps and materials. The securing mechanisms are configured to operate in an advantageous manner in order to prevent removal of a bulb from a fixture after installation. Additionally, the disclosed configurations also may prevent transmission of torque to a screw base to avoid damage, provide a snap-in feature allowing installation using insertion force, allow installation of a secured bulb with a locking device into a small diameter, recessed cover, manage heat produced by a lamp, and comprises an inexpensive locking configuration.

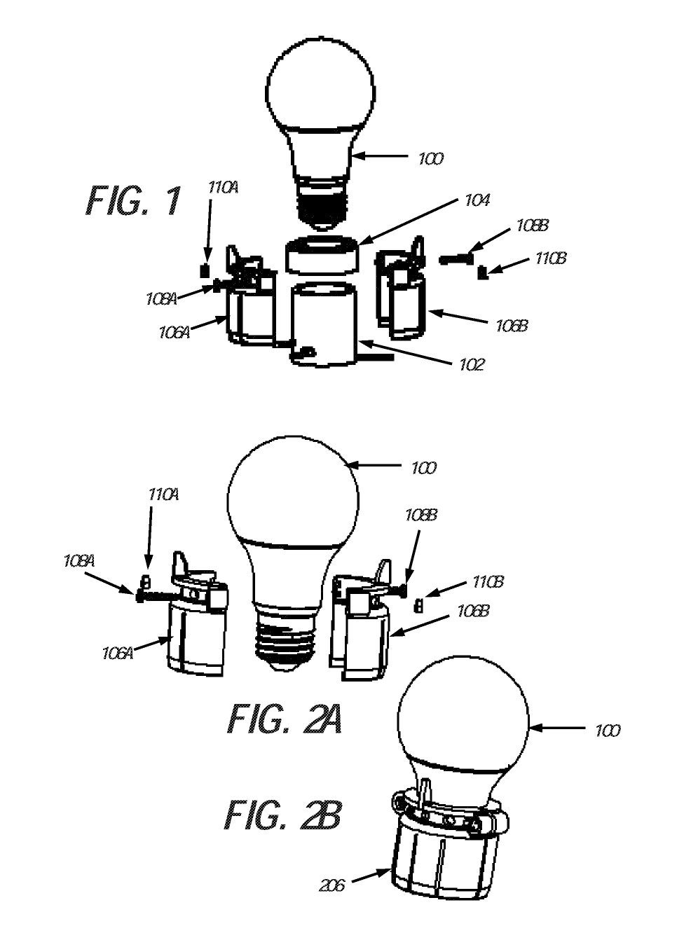

Turning to FIG. 1, an exemplary embodiment is shown comprising a light bulb 100 that may be part of a luminaire that may receive locking clamp assembly anchor 104 that may be positioned within lamp base 102. In one exemplary embodiment, lamp base 102 comprises a cylindrical ceramic insulated material, although it should be understood by those skilled in the art that other suitable materials and shapes may be used as well. As can be seen in the example, a profile matching clamp is disclosed comprising clamp portions 106A and 106B that may be joined along an exterior of lamp base 102 and may be secured by fasteners 108A and 108B and securing blocks 110 and 112. As can be seen in the figure, clamp portions 106A and 106B may have a generally arcuate shape, allowing the clamp portions 106A-106B to encompass the circumference or perimeter of a cylindrical bulb base or other apparatus connected to the bulb base. In certain embodiments, fasteners 108A and 108B may be embodied as screws, bolts, rivets and the like, while securing blocks 110A and 110B may be embodied as a small flat piece of metal or other material that may be square or hexagonal (e.g., hex nut), with a threaded hole or other opening for screwing or securing it onto a bolt as a fastener.

Turning to FIGS. 2A and 2B, the exemplary embodiment illustrates an example where securing clamp portions 106A and 106B are affixed directly to an outer surface of bulb 100, where fasteners 108A-B and securing blocks 110A-B lock the clamp portions together as shown in 206 of FIG. 2B. FIGS. 3A-B illustrate a side view embodiments of securing clamp 206. As can be seen in the figures, the profile of clamp 206 may match the inside diameter profile of the bulb 100 in order to advantageously provide a self-aligning feature during installation. By providing good contact (302) between clamp 206 and bulb 100, thermal resistance may be reduced. Maximizing the contact surface area 302 increases thermal conductivity between bulb 100 and clamp 206. The profile matching both increases alignment of the clamp to the bulb as the clamp portions are tightened and maximizes heat transfer between a bulb and clamp assembly by increasing contact surface area as shown.

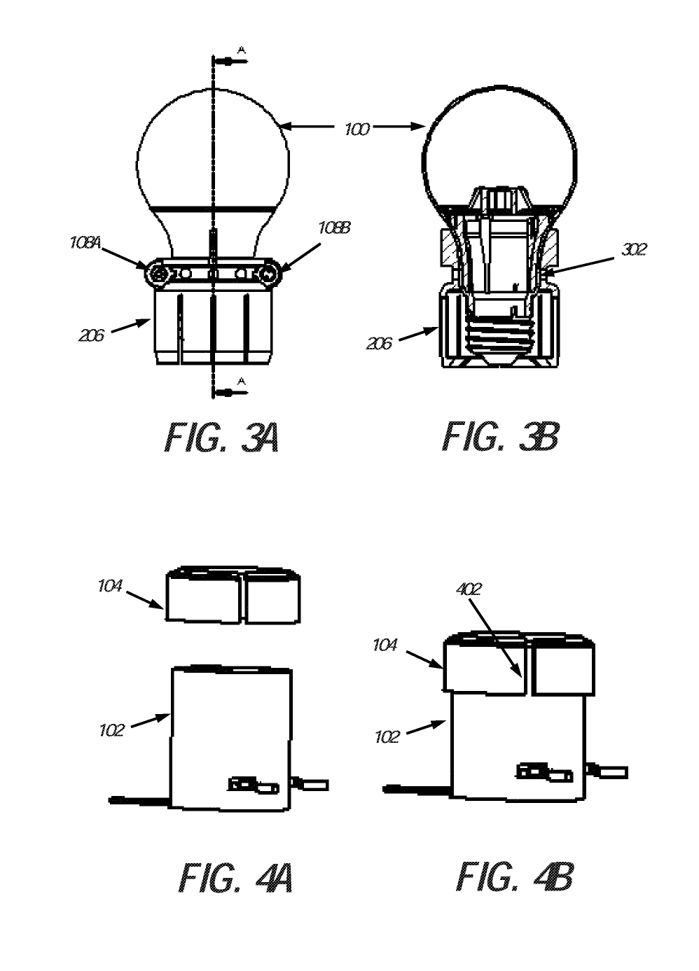

FIGS. 4A-B are illustrative embodiments of an anchor 104 and lamp base 102 assembly, which may be suitable for use in the embodiment described above in connection with FIG. 1. In the illustrated embodiments, anchor 104 may be secured to ceramic base 102 using an adhesive of other suitable fastening techniques. A slot 402 may be provided to allow adjustment of anchor 104 to accommodate varying diameters of lamp base 102.

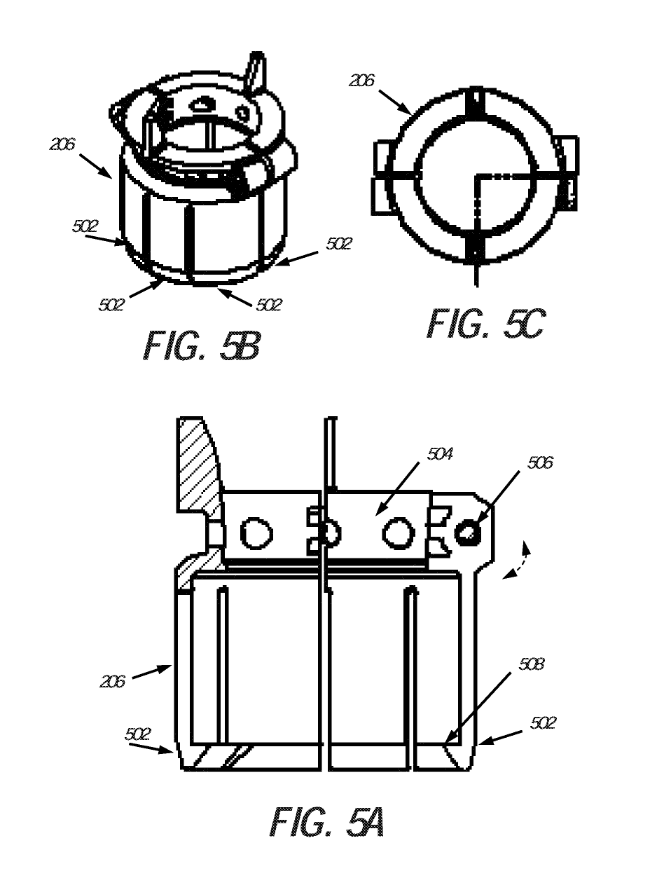

FIGS. 5A-C illustrate various embodiments for a clamp 206 configuration, wherein clamp 206 comprises a plurality of spaced cantilevers 502 (or “fingers”) that may expand and contract, or resiliently pivot as shown by the dotted arrow, in a spring-like fashion along rotation point 506, extending circumferentially around clamp 206. Each finger may be configured to fasten along a bottom portion 508 of the anchor to secure clamp 206 Bottom portion 508 may be configured as a tab as shown, or may be any other suitable shape. In one embodiment, each finger is a cantilever spring with the spring tension controlled by the material used and cross-sectional profile. The spring constant and the number of fingers may determine the insertion and retention force of the bulb. The number, length, cross-sectional area and material used all may be adjusted to control thermal conductivity. Numerous long, thick and wide fingers improve heat transfer away from the bulb via conduction and convection.

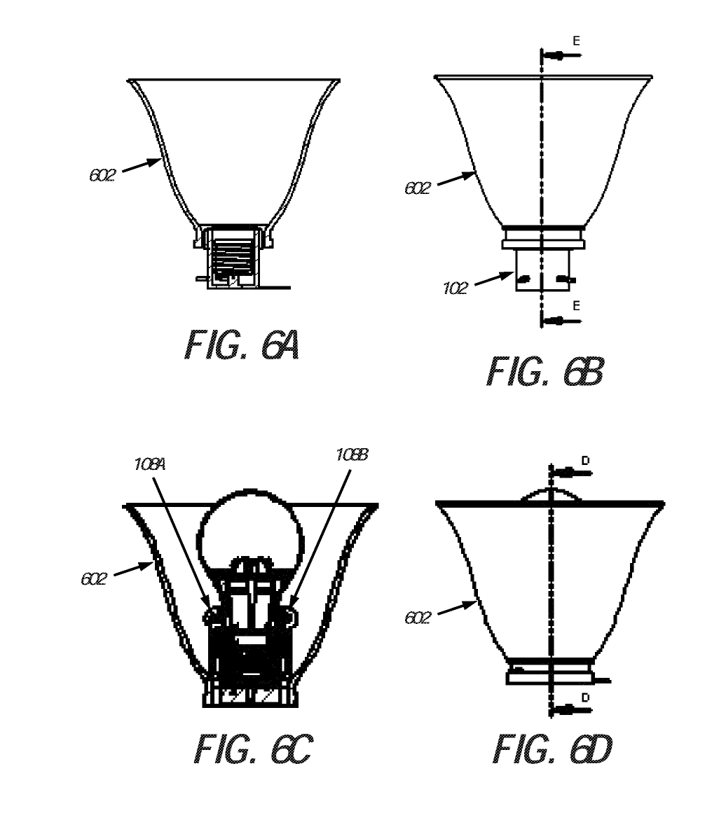

The exemplary embodiments of FIGS. 6A-D illustrate the ability of the bulb and locking mechanism combination to be advantageously installed into a deep recessed fixture 602. In one exemplary installation, the clamp may be installed outside of the fixture, and then insertably coupled into the fixture. Once installed, the bulb may be removed with a custom tool or by loosening fasteners 108A-B. At this point, the bulb may be removed from fixture 602, replaced, and secured by re-tightening fasteners 108A-B and re-engaging the clamp (FIGS. 6C-D). The recessed fixture 602 may be removed after anchor is installed (FIGS. 6A-B).

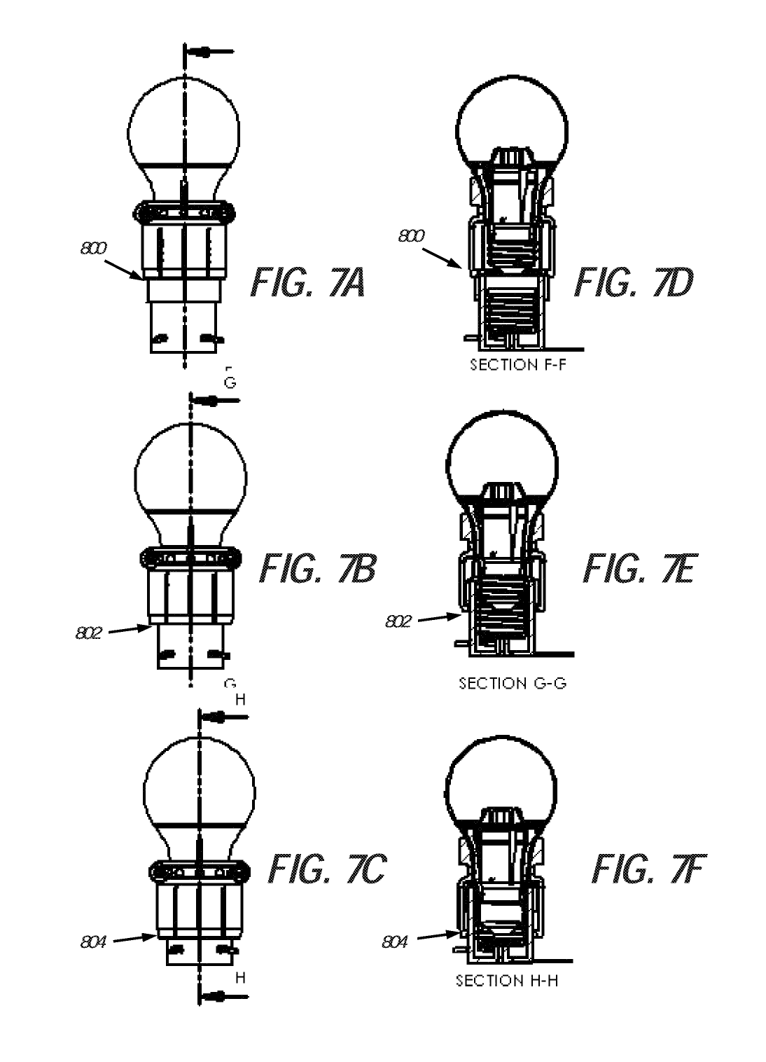

Once the fingers engage the anchor, the bulb cannot be removed normally without releasing fasteners out of the base. In the event a bulb requires removal for replacement/maintenance, it may be removed via fasteners 108A-B without transferring torque to the lamp base, which may cause damage. The exemplary embodiments of 7A-F illustrate various stages of engagement (802-804) of the clamp (FIGS. 7A-C), together with a side cutaway perspective (FIGS. 7D-F).

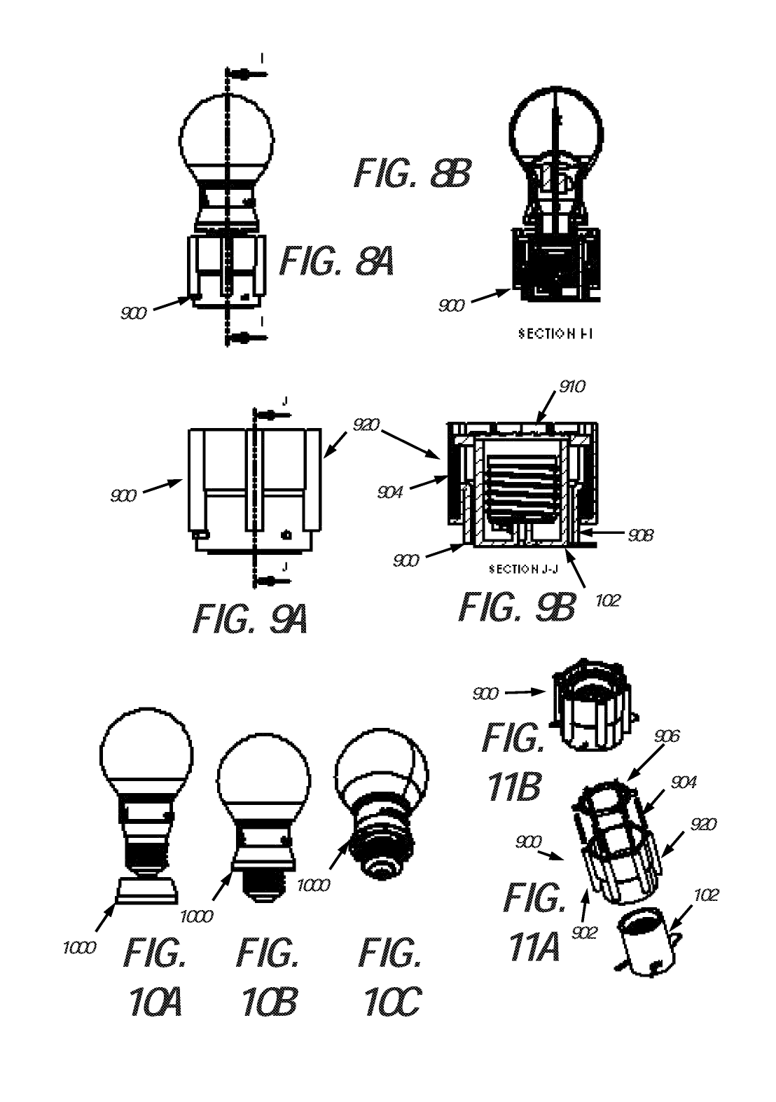

Certain exemplary embodiments are disclosed herein, wherein the locking mechanism employs the use of a locking ring 900 as shown in FIGS. 8A-B, 9A-B and 11A-B. Locking ring 900 may comprise a housing 902 that may be circular or cylindrical in shape, wherein the housing includes hollowed portions 920 for accommodating springs 904 that support floating gear 906. Housing 902 may be bonded (908) to lamp base 102 as shown in FIG. 9B. When assembled, floating gear 906 “floats” within the housing, but may be restricted from rotating by manufacturing teeth or gears 910 on an upper surface of gear 906. Gear 906 may couple to an upper gear 1000 illustrated in the embodiments of FIGS. 10A-C, which may comprise opposing teeth or gears for locking floating gear 906 in place. In the embodiments of FIGS. 10A-C, upper gear 1000 may be welded, adhered, or otherwise affixed to a bulb as shown.

As a lamp is installed, upper gear 1000 engages floating gear 906, allowing it to move up or down (via springs 904), but is unable to rotate. As the bulb is inserted, the gears engage and the engagement force increases as the springs are compressed. Accordingly, bulb removal may be hindered via engagement between upper 1000 and floating gear 906 via the ratcheted locking mechanism provided. One advantage of this configuration is that the embodiment does not require the use of security fasteners. Once the assembled housing is installed in the lamp base, a bulb may be installed in the lamp base and locks as the bulb is screwed into place. Removal may be achieved by pushing the floating gear down by direct force or, alternately, by magnet.

Accordingly, a locking mechanism is provided for a lamp bulb, utilizing a locking ring having an upper portion and a lower portion, wherein the locking ring lower portion 900 generally has a circular housing, and the housing includes a plurality of hollowed portions 920 for accommodating springs supporting a floating gear. The locking ring may also include an upper portion 1000 also having a generally circular housing having an upper gear, where the locking ring upper portion 1000 is configured to receive the locking ring lower portion 900, and wherein the floating gear and upper gear comprise teeth that are configured to restrict rotation of the lamp in one direction when the teeth of the floating gear and upper gear are engaged.

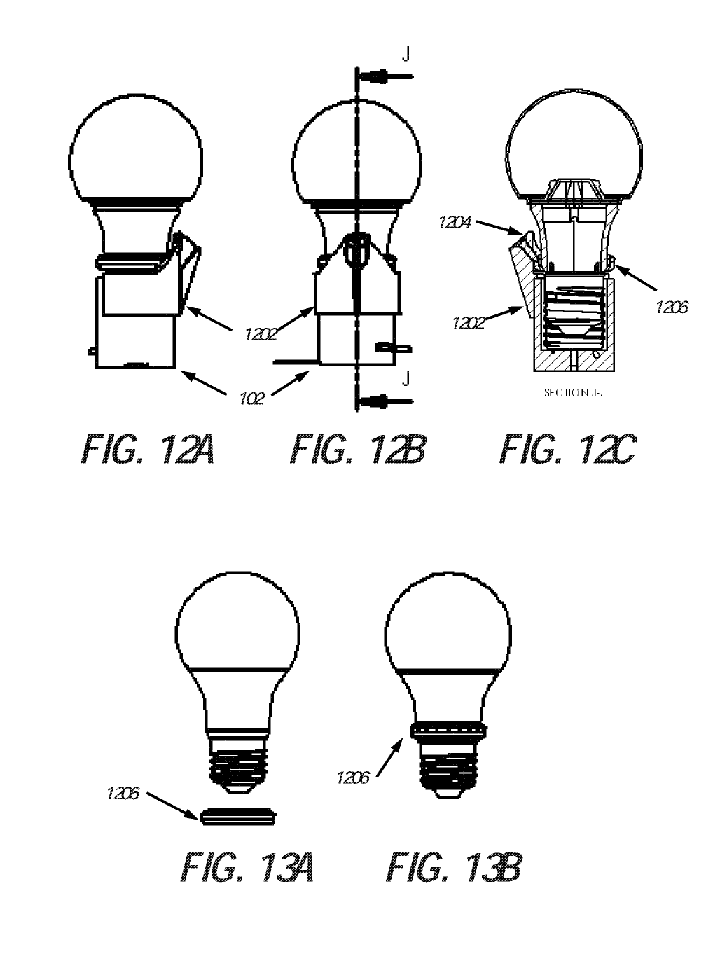

In certain exemplary embodiments, a locking sleeve 1202 (locking ring) may be employed (see FIGS. 12A-C) that is similar to the embodiments described above, particularly in connection with FIG. 1, except that locking sleeve 1202 comprises an extended enclosed opening 1208 for receiving a single fastener 1204 obliquely inserted into ring 1202 as shown in FIG. 12C and the assembly being inserted over lamp base 102. A ring 1206 may be welded, adhered, or otherwise affixed to the lamp bulb as shown in FIGS. 13A-B, where ring 1206 may be used to lock in the bulb to locking sleeve 1202 as shown in FIGS. 14A-B. During installation, locking sleeve 1202 may be inserted into lamp base 102, wherein, after installation, the security fastener 1204 is installed which engages the locking disk and thus secures the bulb into the lamp base. In certain illustrative embodiments, security fastener 1204 may be configured as a micro screw that may be embodiment as a machine screw having illustrative dimensions from M0.6-M3 and #000-#4, as well as thread forming screws from M0.6-M5 and #000-#4. In other illustrative embodiments, security fastener may be configured as a screw having a tamper-proof head. Such a screw may include, but is not limited to, a breakaway head screw, a Bristol screw, a clutch screw, a claw screw, a double-hex screw, line screw, pentalobe screw, polydrive screw, a protruding obstacle or “pin type” screw, spanner screw, spline screw, torq-set screw, a “TA” screw, a “TP3” (or tri-lobe) screw, tri-point screw, tri-wing screw or triple-square screw.

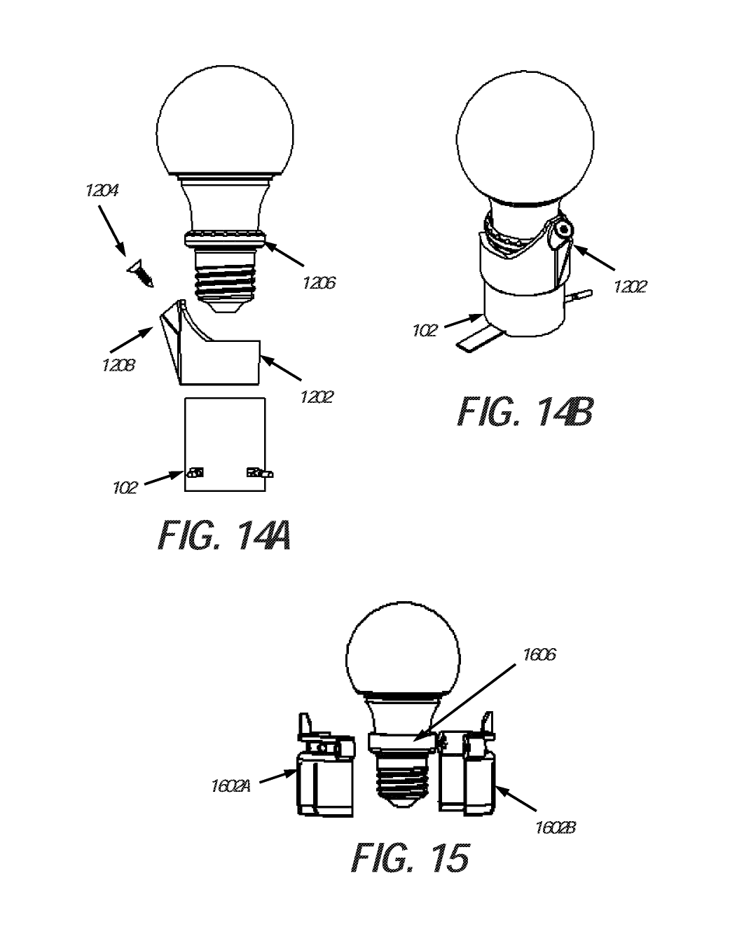

Turning to FIG. 15, another exemplary embodiment is provided where a universal clamp is disclosed comprising clamp portion 1602A and 1602B that may be joined similar to the embodiment of FIG. 1, and secured to universal clamp adapter 1606. The adapter inner diameter may be configured to match the profile of the bulb, while the outer diameter may be made to a predetermined standard size to accommodate a clamp. Using a bonded clamp adapter advantageously allows for any bulb to be modified to work within a clamp in various configurations. This approach additionally allows various types of bulbs to be secured using the universal adapter.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus for locking a luminaire, comprising:
a clamp assembly, comprising
a first clamp portion having an arcuate shape and comprising a first plurality of cantilevers; and
a second clamp portion having an arcuate shape and comprising a second plurality of cantilevers,
wherein the first and second portion are configured to be joined along a circumference of one of (i) a lamp or (ii) a lamp base,
wherein the clamp assembly comprises openings configured to receive at least one fastener for securing the joined first and second portion,
and wherein the clamp assembly is configured to lock the luminaire to a base via the first and second plurality of cantilevers.

2. The apparatus of claim 1, wherein each of the first and second plurality of cantilevers comprise a bottom portion distal to one of the lamp or lamp base.

3. The apparatus of claim 2, wherein each of the bottom portion comprises a tab configured to lock the luminaire to the base.

4. The apparatus of claim 1, wherein each of the first and second plurality of cantilevers are configured to resiliently pivot perpendicularly to the circumference of one of the lamp or lamp base.

5. The apparatus of claim 1, wherein the lamp base comprises a cylindrical shape configured to receive the first and second clamp portions.

6. The apparatus of claim 5, wherein the lamp base comprises a ceramic material.

7. The apparatus of claim 5, further comprising an anchor configured to be coupled to the lamp base, wherein the anchor is configured to couple with the first and second plurality of cantilevers to lock the luminaire.

8. A locking mechanism for a lamp bulb, comprising:
a locking ring comprising an upper portion and a lower portion,
wherein the locking ring lower portion comprises generally cylindrical housing, the housing comprising a plurality of hollowed portions for accommodating springs supporting a floating gear,
wherein the locking ring upper portion comprises a generally circular housing comprising an upper gear, the locking ring upper portion being affixed to the lamp bulb and configured to receive the locking ring lower portion,
wherein the floating gear and upper gear comprise teeth that are configured to restrict rotation of the lamp in one direction when the teeth of the floating gear and lower gear are engaged during installation of the lamp bulb.

9. The locking mechanism of claim 8, wherein the locking ring upper portion is affixed to the lamp bulb by bonding the locking ring upper portion to the lamp bulb prior to installation.

10. The locking mechanism of claim 8, wherein the locking ring upper portion is affixed to the lamp bulb by securing the locking ring upper portion to the lamp bulb with a fastener prior to installation.

11. The locking mechanism of claim 8, wherein the upper portion and lower portion are configured to increase an engagement for the floating gear and upper gear during installation of the lamp bulb.

12. The locking mechanism of claim 8, wherein the floating gear and the upper gear are configured to disengage by applying a force to the floating gear in a direction away from the upper gear.

13. A locking mechanism for a lamp bulb, comprising:
a lock ring configured to be affixed to a base region of the lamp bulb; and
a locking sleeve configured to be coupled to a lamp base, wherein the locking sleeve is configured to insertably receive the base region of the lamp bulb, wherein the locking sleeve comprises an extended enclosed opening configured to receive a fastener that passes into the extended enclosed opening to secure the lock ring to prevent removal of the lamp bulb from the lamp base.

14. The locking mechanism of claim 13, wherein fastener comprises a micro screw.

15. The locking mechanism of claim 13, wherein the fastener comprises a tamper-proof screw.
